(19) United States
(12) Patent Application Publication
(10) Pub. No.: US 2021/0315436 A1
(43) Pub. Date: Oct. 14, 2021

(54) CLEANING ARTICLES MADE OF RECYCLED MATERIAL AND METHODS FOR PRODUCING SUCH CLEANING ARTICLES

(71) Applicant: Illinois Tool Works Inc., Glenview, IL (US)

(72) Inventors: Bradley Taylor Lyon, Winston-Salem, NC (US); Terry Lawrence Cranfill, Lexington, NC (US)

(21) Appl. No.: 17/227,675

(22) Filed: Apr. 12, 2021

Related U.S. Application Data
(60) Provisional application No. 63/009,254, filed on Apr. 13, 2020.

(51) Int. Cl. A47L 13/17; B65D 83/08

(52) U.S. Cl. CPC A47L 13/17; B65D 83/0835

(57) ABSTRACT

This disclosure relates generally to production of clean textiles and, more particularly, to cleaning articles, such as wipers, mops, and swabs, made of a recycled or “upcycled” material for use in a cleanroom environment, and methods for producing such cleaning articles. Such cleaning articles may comprise at least one layer of fabric. The fabric may be formed from at least 50% recycled yarn, and the remainder of the wiper, if any, may be formed from virgin yarn. The recycled yarn may be recycled polyester yarn. The edges of the at least one layer of fabric may be sealed or cut.

### CROSS-REFERENCE TO RELATED APPLICATIONS

This application claims benefit of priority to U.S. provisional patent application No. 63/009,254, entitled “CLEANING ARTICLES MADE OF RECYCLED MATERIAL AND METHODS FOR PRODUCING SUCH CLEANING ARTICLES”, filed Apr. 13, 2020, the contents of which are herein incorporated by reference in their entirety.

### FIELD

This disclosure relates generally to production of clean textiles and, more particularly, cleaning articles—such as wipers, flat and string type mops, and swabs—made of a recycled or “upcycled” material for use in a cleanroom and sterile cleanroom environment, and methods for producing such cleaning articles.

### BACKGROUND

Cleanrooms are used in various settings. These include semiconductor fabrication plants, pharmaceutical and medical device manufacturing facilities, compounding pharmacies, aerospace laboratories, and similar places where extreme cleanliness is required.

Cleanrooms are maintained in isolated areas of a building. In this respect, cleanrooms typically have highly specialized air cooling, ventilation and filtration systems to prevent the entry of air-borne particles. Individuals who enter a cleanroom will wear special clothing and gloves. Such individuals may also use specialized notebooks and writing instruments.

It may desirable to clean equipment within a cleanroom. For example, in semiconductor fabrication cleanrooms, surfaces must be frequently wiped or mopped. In order to clean, wipers, mops, and cleaning solutions may be used. For such applications, the cleaning articles themselves should be exceptionally particle-free, and should have a high degree of wet strength and structural integrity. In this way, the cleaning substrates do not disintegrate when used to clean surfaces, even when dampened by or saturated with a cleaning liquid.

Products used in sensitive areas such as semiconductor fabrication cleanrooms and pharmaceutical manufacturing facilities are carefully selected for certain characteristics. These include low particle emission levels, low levels of ionic contaminants, adsorptiveness, and resistance to degradation by wear or exposure to cleaning materials. The contamination which is to be controlled is often called “micro-contamination” because it consists of small physical contaminants. Such contaminants include matter of a size between that of bacteria and viruses, and chemical contaminants in very low concentrations, typically measured in parts per million or even parts per billion.

Micro-contaminants are usually one of several types: physical particles, ions and microbials, and “extractables.” Extractables are impurities leached from the fibers of a cleaning article. Previously, The Texwipe Company of Upper Saddle River, N.J. (now Texwipe, Division of Illinois Tool Works, of Kernersville, N.C.) has developed wipers especially suited for use in particle-controlled environment. See, e.g., U.S. Pat. Nos. 4,888,229, 5,271,995, and 6,062,381, each to Paley, et al., the disclosures of which are incorporated herein by reference in their entireties to the extent permitted by law. See also U.S. Pat. No. 5,229,181 to Daiber et al. These patents disclose wipers for cleanroom use.

There exists a need for cleaning articles (such as wipers, mops, and swabs) made from recycled or “upcycled” materials.

### SUMMARY

According to an aspect of the present disclosure, a cleaning article made from recycled material may comprise at least one layer of a fabric, wherein the fabric is formed from at least 50% recycled yarn, and the remainder of the fabric, if any, is formed from virgin yarn. The edges of the at least one layer are sealed or cut.

According to another aspect of the present disclosure, a package of wipers may comprise a sheet material container, wherein the container contains a strip or roll of wipers delineated from one another by lines of weakness, and an industrial cleaning liquid absorbed into the wipers. The container may be a dispenser bag or a canister. The container may comprise an outlet fixture forming a restricted outlet opening through which the wipers can be pulled with substantial resistance so as to allow a wiper extending through the outlet opening to be withdrawn and torn free from the strip when pulled out through the outlet opening. The wiper may comprise at least one layer of a fabric. The fabric may be formed from at least 50% recycled yarn, and the remainder of the fabric, if any, may be formed from virgin yarn. The edges of the at least one layer are sealed or cut. The industrial cleaning liquid may comprise a solvent.

According to another aspect of the present disclosure, a method for preparing a cleaning article made from recycled material may comprise weaving, knitting, or bonding recycled polyester yarn formed from recycled polyethylene terephthalate (rPET) bottles to form a cleaning article made from recycled material, wherein the cleaning article comprises at least one layer of a fabric, and wherein the fabric is formed from at least 50% recycled polyester yarn, and the remainder of the fabric, if any, is formed from virgin yarn. The edges of the at least one layer are sealed or cut.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 is a perspective view of a wiper dispenser constructed according to one aspect of the present disclosure;

FIGS. 2 and 3 are perspective views of a portions of the wiper dispenser shown in FIG. 1, with the remainder of the dispenser broken away;

FIG. 4 is a cross-sectional view taken along line 4-4 of FIG. 1;

FIG. 5 is cross-sectional view taken along line 5-5 of FIG. 1;

FIG. 6 is an enlarged cross-sectional view of the material of which the bag shown in FIG. 1 is made;

FIG. 7 is a top plan view of a portion of perforated strip of wiper material stored in the wiper dispenser shown in FIG. 1;

FIG. 8 is a cross-sectional view taken along line 8-8 of FIG. 1, with the cover over the dispensing outlet removed;

FIG. 9 is a perspective view of another wiper dispensing bag according to one aspect of the present disclosure;

FIG. 10 is a cross-sectional and schematic view taken along line 10-10 of FIG. 9;

FIG. 11 illustrates an example wiper according to one aspect of the present disclosure;

FIG. 12 illustrates an example mop according to one aspect of the present disclosure;

FIG. 13 illustrates an example swab according to one aspect of the present disclosure;

FIG. 14 illustrates a flow diagram of a method of producing a cleaning article according to one aspect of the present disclosure; and

FIG. 15 illustrates a bar chart comparing certain properties of cleaning articles formed from virgin PET material compared to cleaning articles formed from recycled PET material.

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Cleanroom applications may benefit from using cleaning articles such as wipers, mops, and swabs to clean surfaces. However, such cleaning articles are not typically made from a recycled material.

Cleaning articles according to the present disclosure may be made from a fabric comprising recycled or “upcycled” polyethylene terephthalate (rPET). Upcycling, also known as creative reuse, is the process of transforming by-products, waste materials, useless, or unwanted products into new materials or products of better quality and environmental value. Here, PET bottles that might otherwise become landfill are being reused as cleaning articles such as cleanroom wipers, mops, and swabs.

One advantage of forming cleaning articles such as wipers from recycled PET (rPET) bottles is that there is an overall reduction in the energy consumption required to produce the cleaning article. In fact, the energy consumption may be reduced by as much as 45%.

Cleaning articles according to the present disclosure may be formed of a fabric comprising a yarn that is polyester, nylon, or a polyester/nylon blend. Polyester may be in the form of filament polyester yarn , spun, or staple polyester yarn. Similarly, nylon may be in the form of filament nylon yarn, spun, or staple nylon yarn. An example cleaning article according to the present disclosure may comprise at least 50% recycled yarn. For example, a cleaning article could be formed of 50% recycled yarn and 50% virgin yarn. Alternatively, an example cleaning article could be formed of fabric that comprises between 1% to 100% polyester yarn (for example 60%, 70%, 80%, or 90% recycled yarn).

Cleaning articles according to the present disclosure may be used for various applications, particularly cleanroom applications, including: wiping and cleaning surfaces, equipment, and parts; spill control; applying and removing lubricants, adhesives, residues, and other solutions including disinfectants; cleaning with solvents; cleaning gloves, notebooks, phones or any other item entering a cleanroom; and lining trays for holding, protecting, drying and storing of parts, equipment and devices.

Cleaning articles according to the present disclosure may be cleanroom laundered and packaged providing ultra-low levels of ions and non-volatile residues and designed for use on various surfaces. The cleaning articles should not easily snag or abrade releasing particles and fibers. The cleaning articles should have excellent chemical resistance for compatibility with a variety of solutions. Cleaning articles according to the present disclosure may have fabric with properties as shown in Table 1.

TABLE 1
Performance Properties

| Property | Typical Value | |
|---|---|---|
| Particles and Fibers | | |
| LPC: ≥0.5 μm | 8.4 × 10⁶ | particles per m² |
| Fibers: >100 μm | 2,000 | fibers per m² |
| Nonvolatile Residue | | |
| IPA extractant | 0.06 | g per m² |
| DIW extractant | 0.01 | g per m² |
| Ions | | |
| Sodium | 0.15 | ppm |
| Potassium | 0.03 | ppm |
| Chloride | 0.10 | ppm |

Cleaning articles according to the present disclosure may comprise fabric that has a sorption capacity of at least 100 mL per m² (for example, 150-200 mL per m², or 300-400 mL per m² or 500-600 mL per m² or 530 mL per m²). The fabric may have a sorption rate of 0.3 seconds or less. The basis weight of the fabric may be 300 g per m² or less (for example, 100-150 g per m², 150-200 g per m², or 200-250 g per m² or 160 g per m²).

Cleaning articles, such as wipers, made with rPET and virgin PET, respectively, may have properties as shown in Table 2. The ion content may be measured by ion chromatography. For example, cleaning articles made with rPET may have a lower sorption capacity than cleaning articles made with virgin PET, while retaining sufficient sorption capacity to be useful as a cleaning article. The basis weight and sorption rate of the cleaning articles may be similar. While there may be some differences in ion values, the differences are not significant to the performance of the cleaning articles.

TABLE 2

| Property | rPET Cleaning Article | | Virgin PET Cleaning Article | |
|---|---|---|---|---|
| Basis Weight | 125-130 | g per m² | 120-125 | g per m² |
| Sorption Capacity | 420-430 | mL per m² | 510-520 | mL per m² |
| Sorption Rate | 0.3 | seconds or less | 0.3 | seconds or less |

| Ions | (approximate ppm) | (approximate ppm) |
|---|---|---|
| Ammonium | 0.8 | 0.1 |
| Bromide | 0.009 | 0.009 |
| Calcium | 0.10 | 0.09 |
| Chloride | 0.07 | 0.03 |
| Fluoride | 0.07 | 0.009 |
| Lithium | 0.009 | 0.009 |
| Magnesium | 0.02 | 0.02 |
| Nitrate | 0.9 | 0.4 |
| Nitrite | 0.03 | 0.02 |
| Phosphate | 0.009 | 0.04 |
| Potassium | 0.1 | 0.06 |
| Sulfate | 0.6 | 0.03 |
| Sodium | 0.3 | 0.1 |

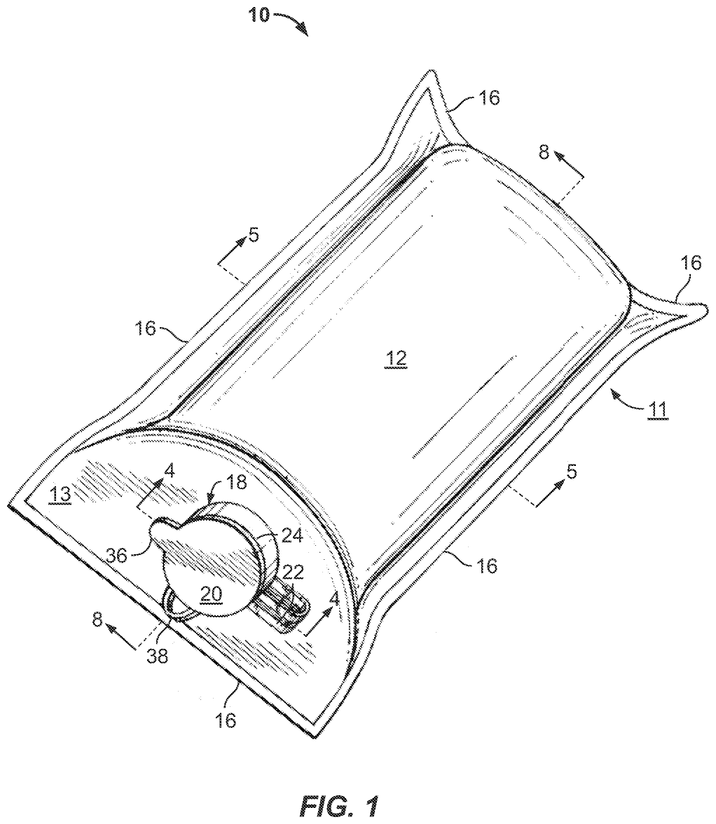

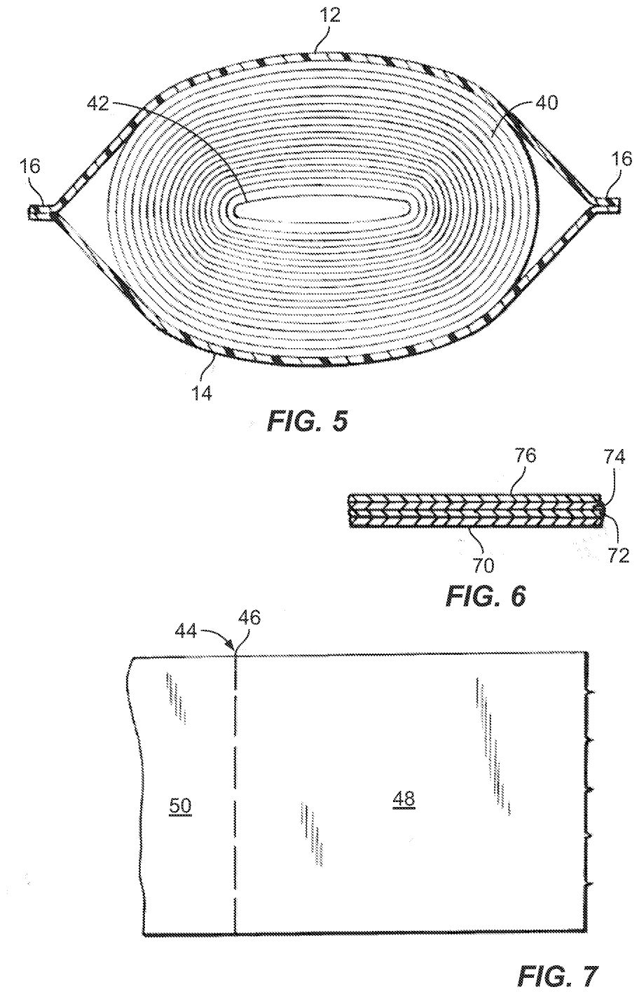

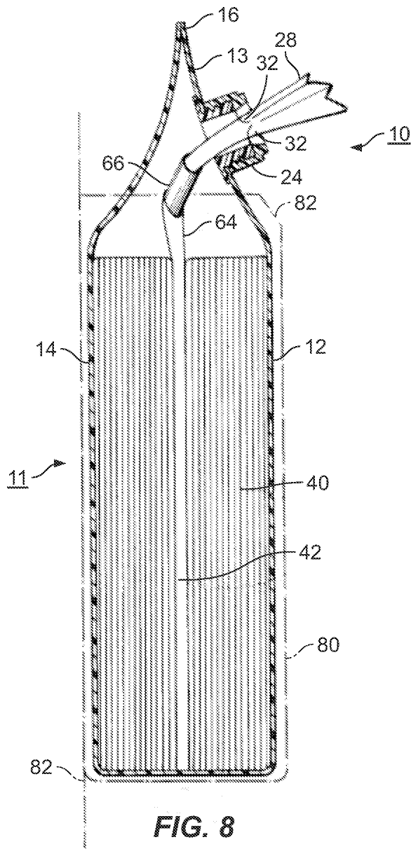

FIG. 1 is a perspective view of a dispensing package 10 constructed in accordance with the present disclosure. The package 10 comprises a bag having a front wall 12 and a rear wall 14 (see FIGS. 5 and 8) which are sealed together at their edges 16 to form a sealed bag.

As it is shown most clearly in FIGS. 5 and 8, the bag has a lower portion 11 and an upper portion 13. The lower portion 11 of the bag contains a strip of wiper material forming a flattened roll 40. The portion 13 extends beyond the portion 11 where the roll 40 is located so as to provide room for a dispensing outlet fixture 18 (FIG. 1).

The outlet fixture 18 (FIG. 1) includes a cylindrical cap base member 24 (also see FIGS. 3 and 4) with a snap-on cap 20 attached to the cylindrical structure 24 by a pair of elongated plastic flexures 22.

The cap base 24 has four pie-shaped flexible plastic tabs 32 which project radially inwardly on the inside of the base 24, with slots 34 separating the projections 32 from one another. Five tabs 32 forming a “star” pattern also can be used. The projections 32 form a restrictive outlet opening structure 30 which impedes the movement of wiper material, such as the wiper 28, when it is pulled outwardly through the outlet opening. The projections 32 bend and flex (as shown in FIG. 8) so as to allow the material to be pulled through the outlet opening with a certain degree of impedance. This allows the wiper material to be pulled out until the leading wiper is torn away from the succeeding portions of the wiper strip.

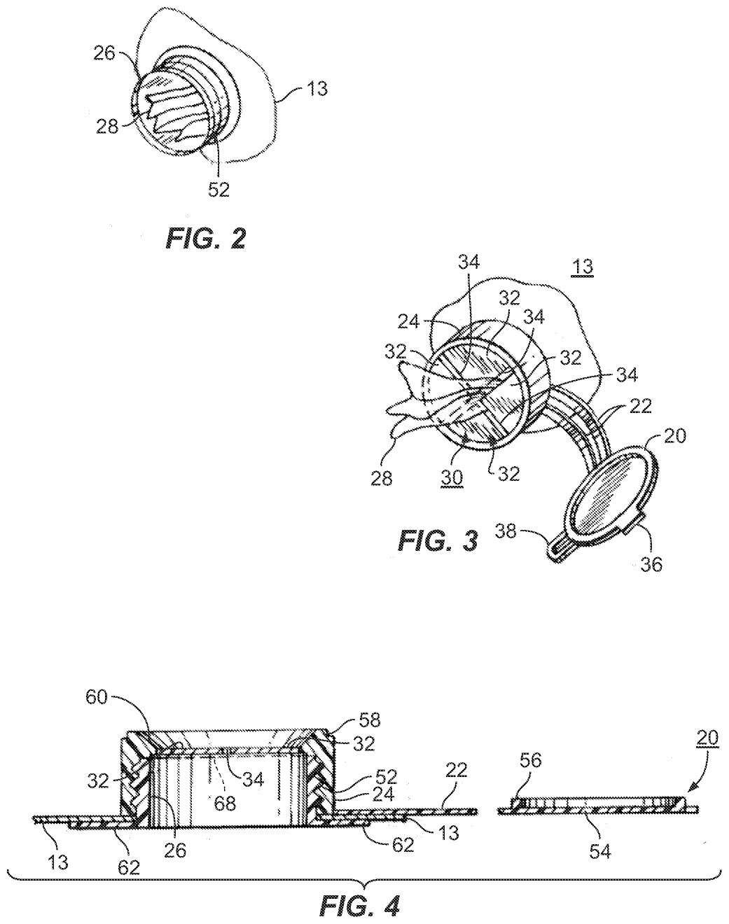

The structure 24 has internal threads and is screwed onto an outlet spout 26 (see FIGS. 2 and 4) which has external threads 52. The cap base structure 24 can be removed from the spout 26 by unscrewing it to gain access to the interior of the bag.

Opening the Bag

When the package 10 (shown in FIG. 1) is shipped from the manufacturer, the outlet opening preferably is sealed by means of a foil covering 68, shown in dashed lines in FIG. 4, over the end of the outlet spout 26 to keep the package securely sealed until ready for use.

As it is shown in FIG. 2, when the dispenser is to be used, the cap base structure 24 is screwed off the spout 26 to expose the interior of the package through the outlet opening. The leading edge of the wiper strip is shown at 28 in FIG. 2. The user grasps the end 28 of the strip, pushes it through the outlet flaps 32 in the base structure 24, and screws the cap structure 24 back on to the spout 26.

As it is shown in FIG. 3, with the cap 20 removed, the end 28 of the wiper strip extends from the outlet opening. The end 28 can be pulled by the user outwardly until the first perforation is reached, at which point the friction of the wiper rubbing against the flaps 32 usually is sufficient to cause the first wiper to tear lose from the subsequent wipers. The user can give the wiper a little harder tug to tear if off, if necessary. Then, the protruding end of the next wiper sheet is pushed back into the spout, if necessary, the lid 20 is snapped shut and the wiper is used.

As it is shown in FIGS. 5 and 8, the roll 40 has a hollow core 42 which is considerably flattened from its normal cylindrical shape. Nonetheless, the roll still issues successive coils of wiper material 64 and 66 (FIG. 8) from the central hole 42, as the outer end 28 of the wiper strip is pulled past the flaps 32.

Outlet Fixture Structure

Referring to FIG. 4 as well as FIGS. 1-3 and 8, the outlet opening fixture 18 is well known. The cap base 24 has a beveled outlet edge at 60, and the flaps 32 are molded integrally into the cap base structure. The flexures 22 and the cap 20 also are molded integrally with the cap base. The cap 20 includes a cover portion 54 with a snap ridge 56 which mates with a groove 58 around the upper outer edge of the base 24 to snap the cover on to and off of the cap base.

The spout structure 26 includes a bottom flange 62 extending outwardly which is bonded to the edges of a circular hole cut in the material 13 of the top portion of the bag. The material of the outlet fixture 18 preferably is polyethylene. The inner surface of the bag material also is polyethylene so that the bag and outlet fixture are easily thermally bonded together.

Wiper Material

As noted above, the wiper material is formed into an elongated strip, a portion of which is shown in FIG. 7. The strip includes a substantial number of individual sheets 48 and 50, usually approximately 100 per roll. The sheets are delineated from one another by perforation lines 46 which are designed so that the material is strong enough to allow it to be pulled out of the opening, but weak enough so that, with a slightly greater pull, the end can be torn lose from the remainder of the strip.

The material of which the strip is made depends upon the use to which the wipers are to be put. For uses in which extremely particle-free wipers are not required, such as in cleaning automobiles, airplanes and other vehicles prior to painting, or at other times, a highly suitable material is a hydroentangled mixture of synthetic fibers and cellulose fibers such as that sold under the trademark “TechniCloth” by the Texwipe Company.

Other usable materials include those which are absorbent, do not fall apart easily when moistened, are resistant to the solvents absorbed into them and are sufficiently inexpensive for the use. The materials also should be capable of using perforations to facilitate tearing.

According to the present disclosure, the materials should be formed of a fabric comprising at least 50% recycled yarn. For example, a cleaning article could be formed of 50% recycled yarn and 50% virgin yarn. Alternatively, an example cleaning article could be formed of fabric that comprises between 1% to 100% polyester yarn (for example 60%, 70%, 80%, or 90% recycled yarn).

Cleaning Liquid

Preferably, the wipers in the roll 40 are pre-moistened when packaged at the factory. This is done by encasing the roll in the bag, and pouring a pre-measured quantity of cleaning liquid into the bag before sealing it with the seal 68. Preferably, the end 28 of the first wiper is pulled outwardly from the center core to a position where it is adjacent the outlet spout 26 so that it can be easily grasped by a user.

The cleaning liquid can be any of a wide variety of liquids used for cleaning purposes, including water, isopropyl alcohol, etc.

For many applications, such as for cleaning the surfaces of aircraft and automobiles before painting, it is preferred to use more aggressive cleaning solvents such as acetone, MPK, MEK or mixtures of those substances together with naphtha and other aromatic hydrocarbons. Such aggressive solvents often are deleterious to the materials of which typical prior art wiper tubs are made.

The quantity of cleaning liquid absorbed into the wiper material varies depending upon the use to which it is to be put. Thus, the quantity can be anywhere from enough to moisten the entire roll, which is approximately 20 to 25 percent of saturation (“wetted”), up to or exceeding absorbive capacity (“saturation”).

In some uses to which the wipers may be put, the cleaning substance will comprise or contain a biocide to be used in killing germs. Such wipers often are used in pharmaceutical manufacturing to clean and sterilize working surfaces. Therefore, the term “cleaning liquid” as used herein includes biocides or mixtures of biocides with other liquids.

Bag Material

In accordance with one aspect of the present disclosure, the material of which the bag containing the wiper roll is made, consists of a laminate including at least one layer of metal foil, preferably aluminum foil, to serve as a vapor barrier, and a plurality of plastic layers.

As it is shown in FIG. 6, which is an enlarged cross-sectional view of the bag material, an inner layer 70 of polyethylene of 0.0002″ thickness is provided. Secured to this is a layer 72 of polyester, then the layer 74 of aluminum foil, and an outer layer 76 of polyester. The aluminum layer is 0.00035″ thick, and the polyester layers are 0.00048″ in thickness. Each layer is secured to the succeeding layer using permanent adhesives resistant to solvent attack.

The laminate differs from prior laminates for similar bags primarily in the addition of the inner layer 72 of polyester between the polyethylene layer and the foil layer.

Applicant has recognized that the polyethylene is brittle and tends to crack under normal handling and that such cracks also tend to cause the metal foil to tear. The polyester layer is more flexible and minimizes the tearing of the foil.

The laminate is known for use in bags for iodine solution used in hospitals, etc., but is not believed to be known for use in wiper bags.

The laminate also is strong and tough enough to resist tearing when a wiper is being pulled out of the bag.

Portability

FIG. 8 illustrates the compactness and portability of the dispenser 10. Because the roll 40 has been flattened to a high degree, the entire package is less bulky to carry then if the roll were cylindrical. Thus, the package can be inserted into a large pocket 80 in the work clothing 82 of a worker so that it can be carried with the worker and will be very handy. The pocket 80 preferably has an upper edge which is restricted as by means of a button flap so as to hold the bag down against an upwardly and outwardly pull on the wiper material 28.

The pocket 80 also can represent a tool pouch or shop apron worn around a worker's waist, or a receptacle for holding the dispenser 10 at a workstation.

Although the preferred form of the bag shown in FIGS. 1-8 is one formed by two sheets, heat-sealed together at the edges, it should be understood that other bag constructions can be used instead, if desired. For example, a bag also can be made out of tubular material which is cut off and heat-sealed at both ends to form a closed bag. Other bag structures can be used as well.

Zip-Pack

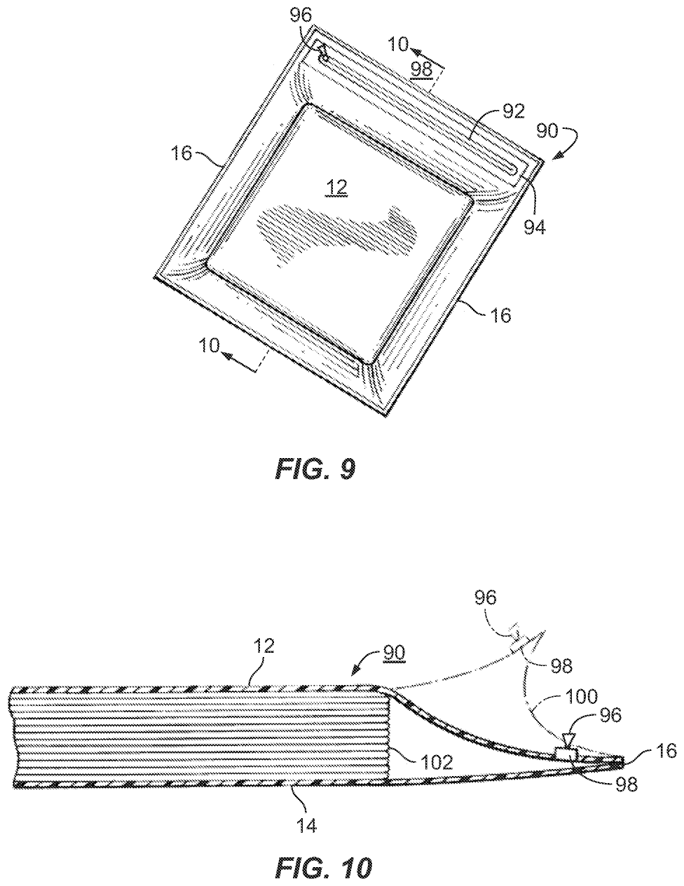

FIGS. 9 and 10 shown an alternative embodiment according to the present disclosure which is shown in use for housing and dispensing separate individual wipers, as opposed to those in a strip formed into a roll. The bag 90 has a front wall 12 and a rear wall 14 (FIG. 10) secured together along a border 16 around the entire package.

Rather than a circular hole into which a dispenser fixture is secured, as in the embodiment shown in FIGS. 1-8, the bag 90 has a wide opening formed along the majority of one side of the bag, which is closed by a plastic or metal slide fastener 92. The slide fastener is conventional, comprising elongated continuous flexible polyethylene grippers 98 heat sealed to the edges of the bag opening as shown in FIG. 10, and a slide fastener 96 which forces the grippers together or separates them, depending upon which direction it is moved.

A disposable label using pressure sensitive adhesive (PSA) 94 covers the zipper structure for shipping and storage until ready for use.

As is it shown in FIG. 10, which is a cross-sectional view of a portion of the bag 90, the bag contains a plurality of separate wipers 102, stacked one on top of the other. The wipers can be made of any of a variety of woven, knitted or hydroentangled natural or synthetic fibers. They can be folded or unfolded. For example, in automobile manufacturing, it is desired to have quarter-folded wipers; that is, wipers which are folded once and then folded a second time. However, in clean room applications, it usually is preferred to have wipers which are folded differently, either with the edges folded over once and again upon themselves, as with facial tissues, or simply flat and unfolded.

The wipers 102 are pre-moistened with pre-determined quantities of liquid cleaning solutions as with the wipers described above and stored in roll form.

When the user desires to remove a wiper from the bag 90 for use, the disposable label 94 is removed and discarded, and the zipper pull 96 is moved from its closed position to the opposite end, the upper edge of the top wall 12 is lifted up, as shown in dashed lines 100 in FIG. 10, and the user can easily withdraw one or more of the wipers from the package. Then, when finished, the user can slide the slider 96 to its initial position to reclose the package.

The zipper type package shown in FIGS. 9 and 10 is easier to use and more certainly re-closable than prior similar bags using an adhesive strip as a closure over a hole. This type of package also is better than zip-lock closures where two strips of polyethylene snap together to form a liquid seal.

The opening through which wipers can be withdrawn is much larger and easier to use. The zipper uses no adhesives which can stick to the hands and gloves of the user. In addition, it is not necessary to make certain that the surfaces onto which the prior adhesive strip is attached are smooth so as not to leave any gaps in the closure of the package. Thus, it is easier to securely close the bag.

In addition, the slider 96 can be easier to operate, especially if the user is wearing gloves, than an adhesive strip, which might require one to push his or her fingernails underneath the edge of the strip to lift it, thus requiring the removal of gloves.

Preferably, the material of which the walls of the bag 90 are made is the same as that for the bag shown in FIGS. 1-8, thus making the bag more versatile and usable with a wide variety of both aggressive and milder cleaning solutions. Some of the elements described herein are identified explicitly as being optional, while other elements are not identified in this way. Even if not identified as such, it will be noted that, in some examples, some of these other elements are not intended to be interpreted as being necessary, and would be understood by one skilled in the art as being optional.

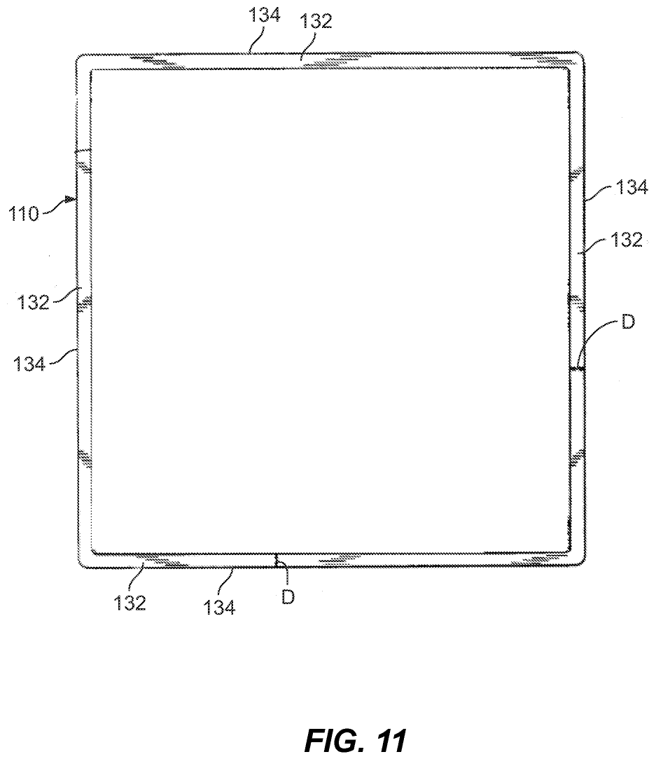

FIG. 11 illustrates an example wiper 110 according to the present disclosure. Wipers according to the present disclosure comprise at least one layer of fabric. A wiper comprising one layer of fabric may be described as 1-ply fabric. Similarly, a wiper comprising two layers of fabric may be described as 2-ply fabric. The edges of a layer of fabric may be sealed or cut. Sealed edges may comprise a sealed border (with a ribbon bonded to the edge) or a sealed edge (in which case the edge itself is sealed). The wiper 110 shown in FIG. 11 comprises a sealed edge 134 with a ribbon 132 having a thickness D bonded to the sealed edge 134. According to the present disclosure, the wiper 110 is formed of a fabric comprising at least 50% recycled yarn. For example, the wiper 110 could be formed of 50% recycled yarn and 50% virgin yarn. Alternatively, the wiper 110 could be formed of fabric that comprises between 1% to 100% polyester yarn (for example 60%, 70%, 80%, or 90% recycled yarn).

Wipers according to the present disclosure may come in various sizes, such as (length×width): 4″×4″, 6″×6″, 9″×9″, 9″×31″, 9″×32″, 12″×12″, and 24″×44″. The wipers may be packaged in bags or boxes containing multiple wipers (for example, 25, 50, 75, 100, 150, 200, or 300 wipers per bag). Wipers may be packaged dry or pre-wetted and in sterile dry and pre-wetted forms. Pre-wetted wipers may be wetted with a degreaser or a solvent such as isopropyl alcohol (IPA), such as a 70% IPA blend, or acetone.

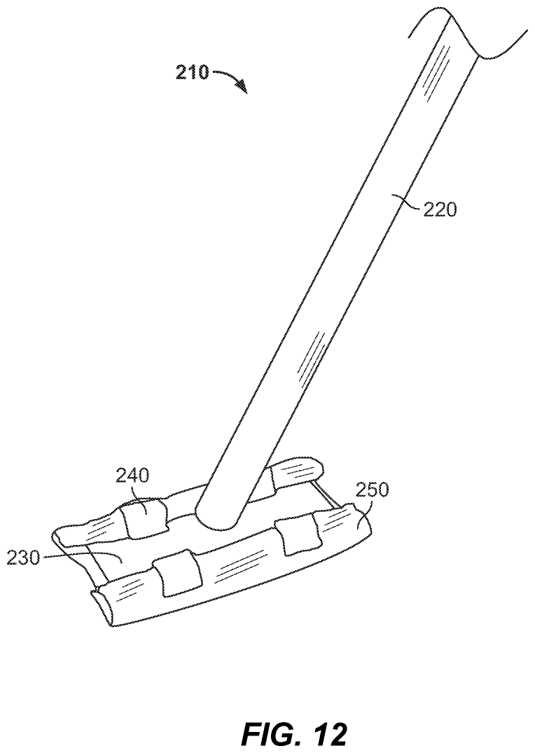

FIG. 12 illustrates an example mop 210 according to the present disclosure. Mops according to the present disclosure may comprise a handle 220 (in the form of a rod or pole) and a mop head 230. A cleaning sheet 250 may be attached to the mop head 230 by one or more clips 240. The cleaning sheet 250 comprises at least one layer of a fabric. According to the present disclosure, the cleaning sheet 250 is formed of a fabric comprising at least 50% recycled yarn. For example, the cleaning sheet 250 could be formed of 50% recycled yarn and 50% virgin yarn. Alternatively, the cleaning sheet 250 could be formed of fabric that comprises between 1% to 100% polyester yarn (for example 60%, 70%, 80%, or 90% recycled yarn).

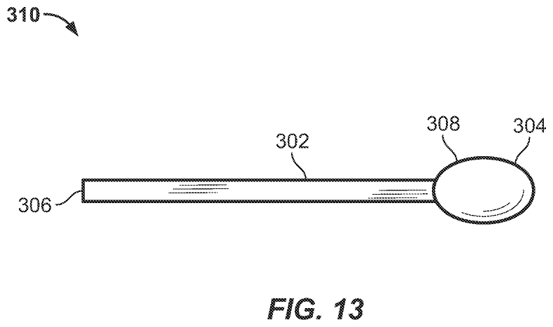

FIG. 13 illustrates an example swab 310 according to the present disclosure. The swab 310 has a stem 302 having a proximal end 306 and a distal end 308. The stem 302 may be solid or hollow. An absorbent tip 304 may be fixedly attached to the distal end 308 of the stem 302. The absorbent tip 304 comprises at least one layer of a fabric. According to the present disclosure, the absorbent tip 304 is formed of a fabric comprising at least 50% recycled yarn. For example, the absorbent tip 304 could be formed of 50% recycled yarn and 50% virgin yarn. Alternatively, the absorbent tip 304 could be formed of fabric that comprises between 1% to 100% polyester yarn (for example 60%, 70%, 80%, or 90% recycled yarn).

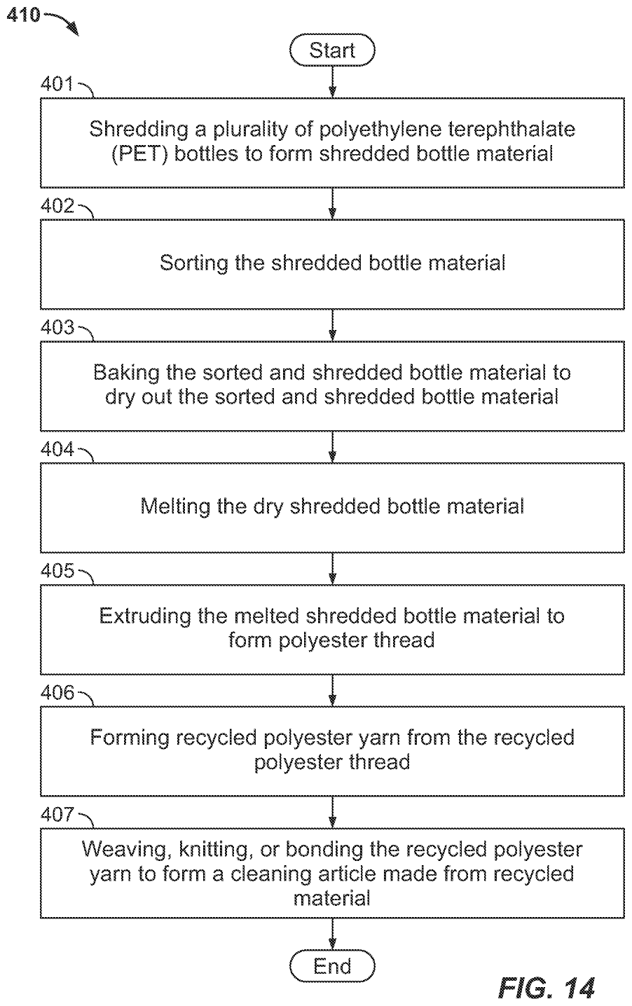

FIG. 14 illustrates a flow diagram showing an example method 410 of producing a cleaning article according to the present disclosure. Under this example method 410, a plurality of polyethylene terephthalate (PET) bottles that have been collected are shredded to form a shredded bottle material or flake 401. The shredded bottle material may then be sorted to remove labels and bottle lids 402. The sorting process may be, for example, a wet process. As an alternative to sorting after shredding, the PET bottles may be sorted prior to shredding. After sorting, the sorted shredded bottle material may be baked to dry out the shredded bottle material 403. After drying out the shredded bottle material, the shredded bottle material may be melted 404. The shredded bottle material may be melted into chip form, which may then itself be melted. After melting, the material may be extruded to form a recycled polyester thread 405. This recycled polyester thread can then be formed into recycled polyester yarn 406. The recycled polyester yarn may then be interlaced (for example, by weaving, knitting, or bonding) to form a fabric 407. As such, the resulting fabric may be woven, knitted, or nonwoven (a term used for a fabric that is neither woven nor knitted but is instead bonded together by chemical, mechanical, heat or solvent treatment). The recycled polyester yarn may be blended with virgin polyester yarn in order to make a fabric that contains some, but not all, recycled polyester yarn. The fabric may be used to make a cleaning article (such as a wiper, mop, or swab) that contains some or all recycled polyester yarn.

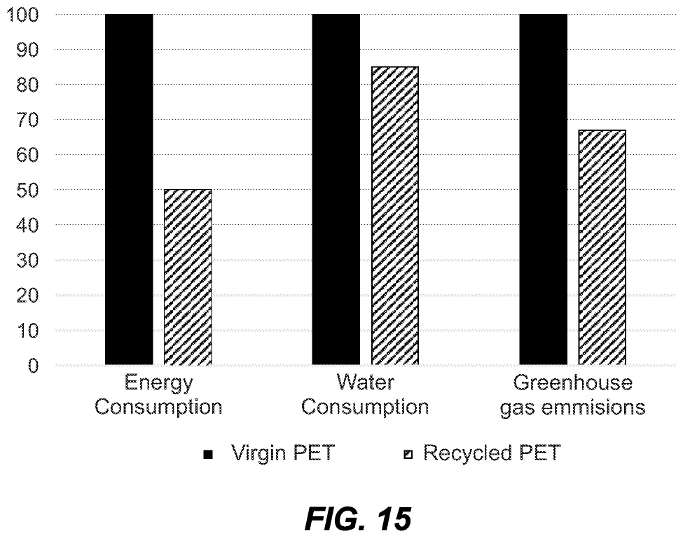

FIG. 15 is a bar chart that illustrates certain advantages of forming cleaning articles from recycled PET instead of virgin PET in terms of reducing energy consumption, water consumption, and greenhouse gas emissions. The properties of the virgin PET materials have been normalized to a scale of 100% to show the approximate percentage reductions achieved by using recycled PET.

While the present disclosure has been described with reference to certain implementations, it will be understood by those skilled in the art that various changes may be made and equivalents may be substituted without departing from the scope of the present method or system. In addition, many modifications may be made to adapt a particular situation or material to the teachings of the present disclosure without departing from its scope. For example, systems, blocks, or other components of disclosed examples may be combined, divided, re-arranged, or otherwise modified. Therefore, the present disclosure is not limited to the particular implementations disclosed. Instead, the present disclosure will include all implementations falling within the scope of the appended claims, both literally and under the doctrine of equivalents.

What is claimed is:

1. A cleaning article made from recycled material comprising:
at least one layer of a fabric, wherein the fabric is formed from at least 50% recycled yarn, and the remainder of the fabric, if any, is formed from virgin yarn, and
wherein the edges of the at least one layer are sealed or cut.

2. The recycled cleaning article of claim 1, wherein the fabric is formed of at least 70% recycled yarn.

3. The recycled cleaning article of claim 1, wherein the fabric is formed of 100% recycled yarn.

4. The recycled cleaning article of claim 1, wherein the recycled yarn is recycled polyester yarn.

5. The recycled cleaning article of claim 1, wherein the recycled yarn is recycled nylon yarn.

6. The recycled cleaning article of claim 1, wherein the fabric has a sorption capacity of at least 100 mL per m².

7. The recycled cleaning article of claim 1, wherein the fabric has a basis weight of 300 g per m² or less.

8. A package of wipers comprising a sheet material container, wherein the container contains:
a strip or roll of wipers delineated from one another by lines of weakness, and
an industrial cleaning liquid absorbed into the wipers,
wherein the container is a dispenser bag or a canister;
wherein the container comprises an outlet fixture forming a restricted outlet opening through which the wipers can be pulled with substantial resistance so as to allow a wiper extending through the outlet opening to be withdrawn and torn free from the strip when pulled out through the outlet opening,
wherein the wiper comprises at least one layer of a fabric,
wherein the fabric is formed from at least 50% recycled yarn, and the remainder of the fabric, if any, is formed from virgin yarn,
wherein the edges of the at least one layer are sealed or cut, and
wherein the industrial cleaning liquid comprises a solvent.

9. The package of wipers of claim 8, wherein the fabric is formed of at least 70% recycled yarn.

10. The package of wipers of claim 8, wherein the fabric is formed of 100% recycled yarn.

11. The package of wipers of claim 8, wherein the recycled yarn is recycled polyester yarn.

12. The package of wipers of claim 8, wherein the recycled yarn is recycled nylon yarn.

13. The package of wipers of claim 8, wherein the fabric has a sorption capacity of at least 100 mL per m².

14. The package of wipers of claim 8, wherein the fabric has a basis weight of 300 g per m² or less.

15. The package of wipers of claim 8, wherein the solvent is selected from the group consisting of one or more of acetone, isopropyl alcohol, methyl propyl keytone and methyl ethyl keytone, naphtha, and aromatic hydrocarbons.

16. A method for preparing a cleaning article made from recycled material comprising:
weaving, knitting, or bonding recycled polyester yarn formed from recycled polyethylene terephthalate (rPET) bottles to form a cleaning article made from recycled material,
wherein the cleaning article comprises at least one layer of a fabric,
wherein the fabric is formed from at least 50% recycled polyester yarn, and the remainder of the fabric, if any, is formed from virgin yarn, and
wherein the edges of the at least one layer are sealed or cut.

17. The method of claim 16 further comprising, before weaving, knitting, or bonding the recycled polyester yarn, forming the recycled polyester yarn from recycled polyester thread.

18. The method of claim 17 further comprising, before forming the recycled polyester yarn, melting dry shredded bottle material and extruding the melted shredded bottle material to form recycled polyester thread.

19. The method of claim 18 further comprising, before melting the dry shredded bottle material, baking sorted and shredded bottle material to dry out the bottle material.

20. The method of claim 19 further comprising, before baking the shredded bottle material, sorting the shredded bottle material.

21. The method of claim 20 further comprising, before sorting the shredded bottle material, shredding a plurality of polyethylene terephthalate (PET) bottles to form shredded bottle material.
